(19) United States
(12) Patent Application Publication
(10) Pub. No.: US 2010/0080418 A1
(43) Pub. Date: Apr. 1, 2010

(54) PORTABLE SUSPICIOUS INDIVIDUAL DETECTION APPARATUS, SUSPICIOUS INDIVIDUAL DETECTION METHOD, AND COMPUTER-READABLE MEDIUM

(76) Inventor: Atsushi ITO, Ashigarakami-gun (JP)

Correspondence Address: BIRCH STEWART KOLASCH & BIRCH, PO BOX 747, FALLS CHURCH, VA, 22040-0747, US

(21) Appl. No.: 12/568,546

(22) Filed: Sep. 28, 2009

(30) Foreign Application Priority Data
Sep. 29, 2008 (JP) 2008-249677

(51) Int. Cl. G06K 9/00

(52) U.S. Cl. 382/103; 348/143

(57) ABSTRACT

Cameras provided to glasses successively take subject images around a wearer of the glasses. The subject images are searched to detect human face regions, and if human face regions are detected, feature quantities of each face are calculated to detect the face direction and the eye direction, and an eye-gaze direction is detected based on them. Whether or not each person with the detected human face region is looking at the cameras is determined from the eye-gaze direction, and if there is a human face looking at the cameras for a given period of time or more, a person with the human face is determined as being a suspicious individual, and a warning message indicating the detection of the suspicious individual is output to the wearer. Furthermore, the detection information and images can be provided to a device in a remote location.

### BACKGROUND OF THE INVENTION

1. Field of the Invention

The present invention relates to a portable suspicious individual detection apparatus, and specifically relates to a portable suspicious individual detection apparatus that enables a user to obtain information on suspicious individuals in the blind spots of the user.

2. Description of the Related Art

Japanese Patent Application Laid-Open No. 2007-6427 proposes a technique in which images of human faces are taken with cameras for eye-gaze detection, thereby making determination of the persons' interests or whether or not the persons are suspicious individuals.

Japanese Patent Application Laid-Open No. 2002-191043 proposes a technique in which a camera is provided on a pair of glasses to check what a glasses wearer sees from a remote location.

### SUMMARY OF THE INVENTION

However, in the art described in Japanese Patent Application Laid-Open No. 2007-6427, the monitoring cameras can cover (monitor) only fixed objects and areas, and thus, particular individuals cannot be monitoring targets.

Also, although the art described in Japanese Patent Application Laid-Open No. 2002-191043 aims to check what a glasses wearer sees from a remote location, it is not sufficient to only take images of what the glasses wearer sees, considering that the glasses wearer is a target to be protected (protection target).

The present invention has been made in view of such circumstances, and an object of the present invention is to provide a portable suspicious individual detection apparatus that enables to protect a particular individual as a protection target from suspicious individuals.

A first aspect of the present invention provides a portable suspicious individual detection apparatus including: portable suspicious individual detection apparatus comprising: a wearable image pick-up device to be put on a body of a user; a face detecting device which detects a human face region from subject images successively taken by the image pick-up device detects; an eye-gaze direction detecting device which detects an eye-gaze direction of a person with the detected human face region; a sight determining device which determines whether or not the person with the detected human face region is looking at the user, based on the eye-gaze direction detected by the eye-gaze direction detecting device; a time period detecting device which detects an amount of time during which the person with the detected human face region is looking at the user when the sight determining device determines that the person with the detected human face region is looking at the user; a suspicious individual determining device which determines that the person with the detected human face region is a suspicious individual when the amount of time detected by the time period detecting device is a predetermined amount of time or more; and a notification device which provides the user with information indicating the detection of the suspicious individual when the suspicious individual determining device determines that the person with the detected human face region is the suspicious individual.

According to the portable suspicious individual detection apparatus according to the first aspect, subject images successively taken by a wearable image pick-up device are searched to detect a human face region, and upon a human face region being detected, the eye-gaze direction of a person with the detected human face is detected. Whether or not the person with the detected human face region is looking at a user is determined based on the result of detection of the eye-gaze direction, and if it is determined that the person with the detected human face region is looking at the user, an amount of time (time period) during which the person with the detected human face region is looking at the user is detected, and if the detected amount of time is a predetermined amount of time or more, the person with the detected human face region is determined to be a suspicious individual, and information indicating the detection of the suspicious individual is provided to the user. Consequently, it is possible to notice suspicious individuals and notify the user of danger. Accordingly, the user can be protected from danger, enabling the user to avoid danger.

A second aspect of the present invention provides the portable suspicious individual detection apparatus according to the first aspect, wherein the face region detecting device detects, based on the detected human face region, and a face direction and a pupil position of the person with the detected human face region, and wherein the eye-gaze direction detecting device detects the eye-gaze direction of the person with the detected human face region, based on the face direction and the pupil position of the person detected by the face region detecting device.

In the portable suspicious individual detection apparatus according to the second aspect, a face direction and a pupil position of the person with the detected human face region are detected, and the eye-gaze direction of the person is detected based on the detected face direction and pupil position. Consequently, the eye-gaze direction can reliably be determined.

A third aspect of the present invention provides the portable suspicious individual detection apparatus according to the first or second aspect, further including a person position detecting device which detects a position of the person with the detected human face region relative to the user, wherein the notification device notifies the user of the position of the person with the detected human face region relative to the user, the position being detected by the person position detecting device when the suspicious individual determining device determines that the person with the detected human face region is a suspicious individual.

In the portable suspicious individual detection apparatus according to the third aspect, when the face region is detected from the images, the position of the person with the detected human face region relative to the user is detected, and if the person with the detected human face region is determined to be a suspicious individual, the user is notified of the position of the person with the detected human face region relative to the user. Consequently, it is possible to notify the user of the position of the suspicious individual in addition to the existence of the suspicious individual. Accordingly, the user can properly notice suspicious individuals and more reliably avoid danger.

A fourth aspect of the present invention provides the portable suspicious individual detection apparatus according to any of the first to third aspects, further including an age/gender determining device which detects at least one of a gender and an age of the person with the detected human face region, based on the detection result of the human face region, wherein the notification device notifies the user of at least one of the gender and the age detected by the age/gender determining device when the suspicious individual determining device determines that the person with the detected human face region is a suspicious individual.

In the portable suspicious individual detection apparatus according to the fourth aspect, when the face region is detected from the images, at least one of the gender and age of the person with the detected human face region is detected based on the detection result, and if the person with the detected human face region is determined to be a suspicious individual, the user is notified of at least one of the detected gender and age of the user. Consequently, it is possible to notify the user of detailed information on the suspicious individual such as the gender and age in addition to the existence of the suspicious individual. Consequently, the user can properly notice suspicious individuals and more reliably avoid danger.

A fifth aspect of the present invention provides the portable suspicious individual detection apparatus according to any of the first to fourth aspects, further including a distance estimating device which estimates a distance to the person with the detected human face region, wherein the notification device provides the user with a warning when the suspicious individual determining device determines that the person with the detected human face region is a suspicious individual and when the distance to the person with the detected human face region estimated by the distance estimating device become a predetermined distance or less.

In the portable suspicious individual detection apparatus according to the fifth aspect, when the face region is detected from the images, a distance to the person with the detected human face region is estimated, and if the person with the detected human face region is determined to be a suspicious individual and the distance to the person with the detected human face region become a predetermined distance or less, a warning is provided to the user. Consequently, the user can be notified of the suspicious individual approaching, in addition to the existence of the suspicious individual.

A sixth aspect of the present invention provides the portable suspicious individual detection apparatus according to any of the first to fifth aspects, further including a transmission device which transmits information indicating that the suspicious individual is detected, and an image of the suspicious individual taken by the image pick-up device to an external device when the suspicious individual determining device determines that the person with the detected human face region is the suspicious individual.

According to the portable suspicious individual detection apparatus according to the sixth aspect, when the person with the detected human face region is determined to be a suspicious individual, information indicating that a suspicious individual is detected and an image of the person who is determined to be the suspicious individual, which is taken by the image pick-up device are transmitted to an external device. Consequently, information useful for protection activities for the user and criminal searching can be transmitted to an external device, such as a mobile phone or PC (personal computer) owned by a guardian, for example.

A seventh aspect of the present invention provides the portable suspicious individual detection apparatus according to the sixth aspect, further including an apparatus position acquiring device that acquires positional information for the portable suspicious individual detection apparatus, wherein the transmission device transmits the positional information acquired by the device position acquiring device when the suspicious individual determining device determines that the person with the detected human face region is a suspicious individual.

In the portable suspicious individual detection apparatus according to the seventh aspect, positional information for the portable suspicious individual detection apparatus is acquired, and the acquired positional information is transmitted to the external device in addition to the information indicating that a suspicious individual is detected and the image of the person with the detected human face region who is determined to be a suspicious individual, taken by the image pick-up device. Consequently, it is possible to know the position where the suspicious individual was found out.

An eighth aspect of the present invention provides the portable suspicious individual detection apparatus according to the sixth or seventh aspect, further including a time information acquiring device which acquires information on a time when the suspicious individual determining device determines that the person with the detected human face region is a suspicious individual, wherein the transmission device transmits the time information acquired by the time information acquiring device when the suspicious individual determining device determines that the person with the detected human face region is a suspicious individual.

In the portable suspicious individual detection apparatus according to the eighth aspect, time information when the person with the detected human face region is determined to be a suspicious individual is acquired, and the acquired time information is transmitted to the external device in addition to the information indicating that a suspicious individual is detected and the image of the person with the detected human face region who is determined to be a suspicious individual, taken by the image pick-up device. Consequently, it is possible to know the time when the suspicious individual was found out.

A ninth aspect of the present invention provides the portable suspicious individual detection apparatus according to any of the sixth to eighth aspects, further including a microphone which collects sound information around the user, wherein the transmission device transmits the sound information collected by the microphone when the suspicious individual determining device determines that the person with the detected human face region is a suspicious individual.

In the portable suspicious individual detection apparatus according to the ninth aspect, a microphone which collects sound information around the user is provided to the apparatus, and the sound information collected by the microphone is transmitted to the external device in addition to the information indicating that a suspicious individual is detected and the image of the person with the detected human face region who is determined to be a suspicious individual, taken by the image pick-up device. Consequently, it is possible to know the circumstances when the suspicious individual was found out.

A tenth aspect of the present invention provides the portable suspicious individual detection apparatus according to any of the first to ninth aspects, wherein the image pick-up device includes a plurality of image sensors; and a plurality of taking lenses which form subject images in different directions from the user on the plurality of image sensors. Consequently, it is possible to notice suspicious individuals from a broader area, and notify a user of danger.

An eleventh aspect of the present invention provides the portable suspicious individual detection apparatus according to the tenth aspect, wherein: the plurality of taking lenses are provided to the image pick-up device in a manner that the plurality of subject images formed on the plurality of image sensors partially overlap; the portable suspicious individual detection apparatus further comprises a combination device which combines overlapping parts of the plurality of subject images formed on the plurality of image sensors in a manner that the plurality of subject images partially overlap, to create a composite image; and the face detecting device detects the human face region from the composite image created by the combination device.

In the portable suspicious individual detection apparatus according to the eleventh aspect, overlapping parts of a plurality of images formed on a plurality of image sensor in a manner that the plurality of images partially overlap are combined to create one composite image, and a human face region is detected from the one composite image obtained as a result of the combination. Consequently, for detection of a human face region, it is enough to perform processing only for one composite image, enabling reliable face region detection.

A twelfth aspect of the present invention provides the portable suspicious individual detection apparatus according to the tenth or eleventh aspect, wherein the image pick-up device is provided on a pair of glasses, and takes at least subject images in front of, and to the left and right of the user.

In the portable suspicious individual detection apparatus according to the twelfth aspect, a plurality of image sensors are provided on a pair of glasses, and take at least subject images in front of and to the left and right of the user wearing the glasses. Consequently, a protection target, that is, a user wearing glasses, can be protected simply by having the protection target wear the glasses.

A thirteenth aspect of the present invention provides the portable suspicious individual detection apparatus according to the tenth or eleventh aspect, wherein the image pick-up device is provided on a hat or a helmet, and takes at least an subject image behind the user.

In the portable suspicious individual detection apparatus according to the thirteen aspect, a plurality of image sensors are provided on a hat or a helmet, and take at least images of subjects behind the user wearing the hat or the helmet. Consequently, a protection target, that is, a user wearing a hat or helmet, can more reliably be protected.

A fourteenth aspect of the present invention provides a suspicious individual detection method including: an image taking step for successively taking subject images using a wearable image pick-up device; a face detecting step for detecting a human face region from the successively-taken subject images; an eye-gaze direction detecting step for detecting an eye-gaze direction of a person with the detected human face region; a sight determining step for determining whether or not the person with the detected human face region is looking at a user of the wearable image pick-up device, based on the detected eye-gaze direction; a time period detecting step for detecting an amount of time during which the person with the detected human face region is looking at the user when it is determined that the person with the detected human face region is looking at the user at the sight determining step; a suspicious individual determining step for determining whether or not the person with the detected human face region is a suspicious individual based on the detected amount of time; and a notification step for providing the user with information indicating the detection of the suspicious individual when it is determined that the person with the detected human face region is a suspicious individual at the suspicious individual determining step.

A fifteenth aspect of the present invention provides a computer-readable medium encoded with a computer program, the program comprising computer-executable instructions to make a computer execute the portable suspicious individual detection method according to the fourteenth aspect.

The present invention enables protection of a particular individual as a protection target from suspicious individuals.

### BRIEF DESCRIPTION OF THE DRAWINGS

FIG. 1 is a schematic diagram of a portable suspicious individual detection apparatus 1 to which an embodiment of the present invention has been applied;

FIG. 2 is a diagram illustrating an arrangement of camera-#1 12 to camera-#5 16 provided to glasses 10;

FIG. 3 is a block diagram of a portable suspicious individual detection apparatus 1;

FIG. 4 is a flowchart illustrating the flow of processing in a portable suspicious individual detection apparatus 1; and

FIGS. 5A and 5B are conceptual diagrams of processing for combining images for each frame.

### DETAILED DESCRIPTION OF THE PREFERRED EMBODIMENT

### First Embodiment

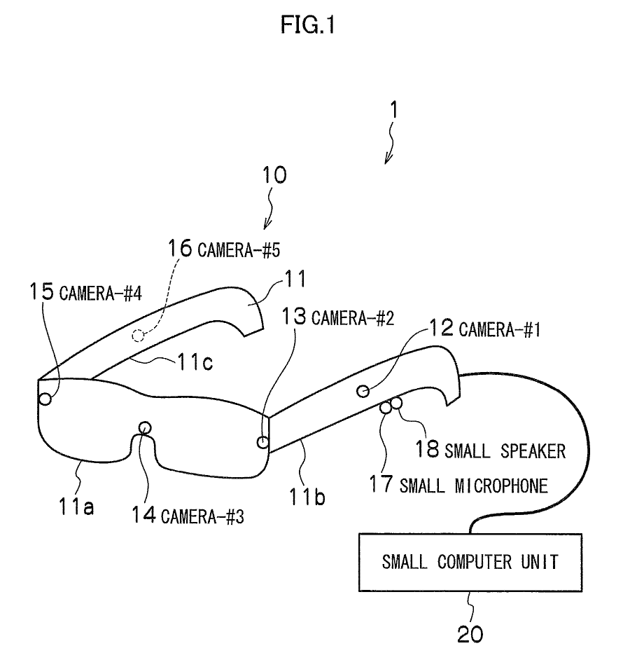

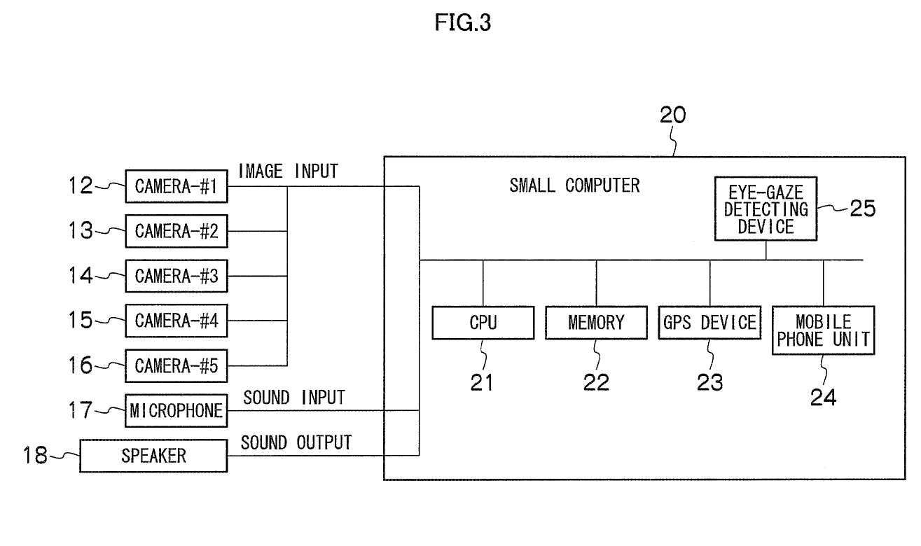

FIG. 1 is a schematic diagram of a portable suspicious individual detection apparatus 1 according to a first embodiment of the present invention. FIG. 3 is a block diagram of the portable suspicious individual detection apparatus 1.

The portable suspicious individual detection apparatus 1, as illustrated in FIG. 1, mainly includes glasses 10 and a small computer unit 20.

The glasses 10 mainly include a glasses body 11, camera-#1 12, camera-#2 13, camera-#3 14, camera-#4 15, camera-#5 16, a small microphone 17 and a small speaker 18.

The glasses body 11 mainly includes a lens frame 11a, a right temple 11c and a left temple 11b. The lens frame 11a is provided with the camera-#2 13, camera-#3 14, and camera-#4 15. The left temple 11b is provided with the camera-#1 12, the small microphone 17 and the small speaker 18. The right temple 11c is provided with the camera-#5 16.

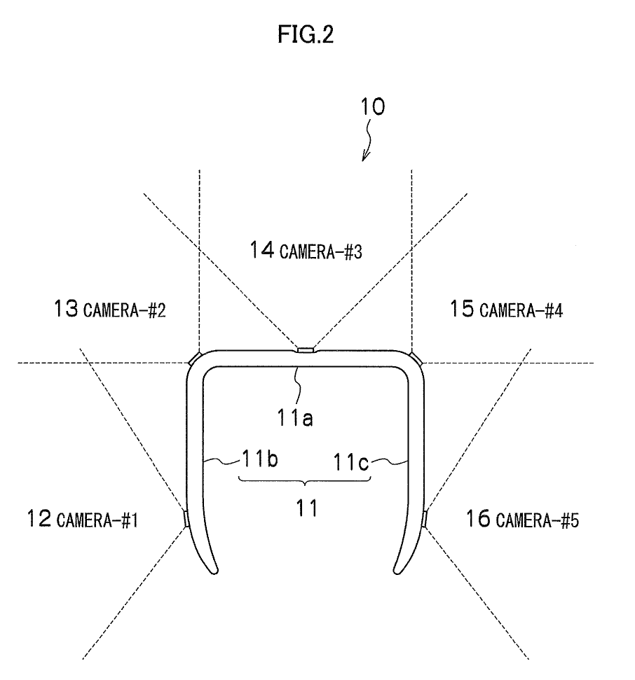

FIG. 2 is a diagram illustrating the arrangement of the camera-#1 12, camera-#2 13, camera-#3 14, camera-#4 15 and camera-#5 16 provided to the glasses body 11, and their respective monitoring ranges.

The camera-#2 13, which is provided on the left front surface of the lens frame 11a, takes images of subjects in front left (front to the left) of a user (glasses wearer). The camera-#3 14, which is provided on the center front surface of the lens frame 11a, takes images of subjects in front of the glasses wearer. The camera-#4 15, which is provided on the right front surface of the lens frame 11a, takes images of subjects in front right (front to the right) of the glasses wearer.

The camera-#1 12, which is provided in the rear of the outer side of the left temple 11b, takes images of subjects in the left of the glasses wearer. The camera-#5 16, which is provided in the rear of the outer side of the right temple 11c, takes images of subjects in the right of the glasses wearer.

Also, the camera-#1 12, camera-#2 13, camera-#3 14, camera-#4 15 and camera-#5 16 are arranged so that images taken by the respective cameras partially overlap. In other words, the camera-#1 12 to camera-#5 16 are arranged in a manner that: the monitoring ranges of the camera-#1 12 and camera-#2 13 partially overlap; the monitoring ranges of the camera-#2 13 and camera-#3 14 partially overlap; the monitoring ranges of the camera-#3 14 and camera-#4 15 partially overlap; and the monitoring ranges of the camera-#4 15 and camera-#5 16 partially overlap.

As a result of arranging the cameras in this a manner, a wide view angle of around 270° with the front as the center can be provided.

The camera-#1 12 includes a taking lens, a CCD image sensor (hereinafter referred to as the “CCD”), an analog processing unit that processes image signals obtained from the CCD, an A/D converter, an image processing unit and a compression/expansion unit, and successively takes subject images to provide a moving image. Since the respective components of the camera-#1 12 are already known, a description thereof will be omitted. Also, since the cameras-#2 13, -#3 14, -#4 15 and -#5 16 each have a configuration similar to that of the camera-#1 12, a description thereof will be omitted.

The small computer unit 20, as illustrated in FIG. 3, mainly includes a CPU 21, a memory 22, a GPS (Global Positioning System) device 23, a mobile phone unit 24 and an eye-gaze detecting device 25.

The CPU 21 functions as a control unit which controls the overall operation of the portable suspicious individual detection apparatus 1 according to predetermined programs, and also functions as an arithmetic unit that performs various arithmetic operations.

The memory 22, which is connected to the CPU 21 via a bus, includes blocks including a non-volatile memory (ROM) area that stores, e.g., programs to be executed by the CPU 21 and various data necessary for control, and a volatile memory (RAM) area used as an area for developing programs and an arithmetic operation work area for the CPU 21. The ROM area is also used as an area for storing sounds and images, and the RAM area is also used as a temporary storage area for image data.

The GPS device 23 simultaneously acquires information on its distances from four or more GPS satellites to obtain its positional information. Also, the GPS device 23 obtains time information from atomic clocks included in the satellites. Since the GPS device 23 is a known technique, a description thereof will be omitted.

The mobile phone unit 24 sends/receives various data such as sounds and images to/from base stations connected to public telephone lines via radio waves. Since the method for communication of various data using the mobile phone unit 24 is a known technique, a description thereof will be omitted.

The eye-gaze detecting device 25 detects regions of human face (face regions) from subject images, and upon detection of face regions, detects the direction of face and/or information on the eyes, such as positions of pupils (direction of eyes) by calculating feature quantities of the face, and detects the direction of eye-gaze (eye-gaze direction) of a person from whom the face region is detected, based on the direction of face and the direction of eyes. As for the eye-gaze detecting device 25, a technique described in, e.g., Japanese Patent Application Laid-Open No. 2007-265367 can be used.

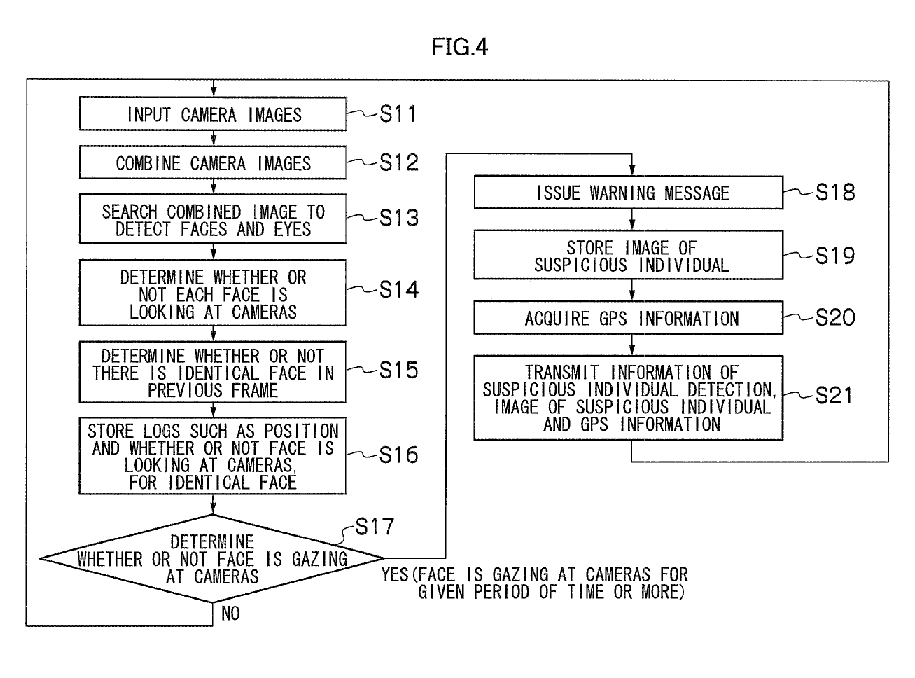

An operation of the portable suspicious individual detection apparatus 1 configured as described above will be described. FIG. 4 is a flowchart illustrating the flow of processing in the portable suspicious individual detection apparatus 1. The following processing is performed mainly by the CPU 21.

When power is turned on by pressing a power supply switch (not illustrated) provided to the glasses body 11, and a user, which is the protection target, puts on the glasses, the CPU 21 starts processing.

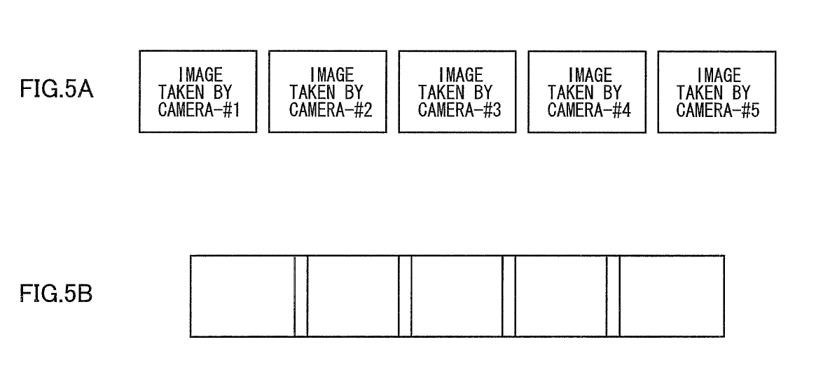

The CPU 21 issues an instruction to the camera-#1 12 to camera-#5 16, and the camera-#1 12 to camera-#5 16 respectively take a subject image (step S11). Consequently, as illustrated in FIG. 5A, five images are taken for one frame. The images for a frame, which have been taken by the camera-#1 12 to camera-#5 16, are each input to the CPU 21 via a bus.

The CPU 21 combines the five images taken by the camera-#1 12 to camera-#5 16 (step S12). The camera-#1 12 to camera-#5 16 are arranged so that images by the cameras partially overlap, and thus, as illustrated in FIG. 5B, the images are combined so that the overlapping parts are overlapped. Consequently, a wide-view-angle frame image is created. The created wide-view-angle frame images are sequentially input from the CPU 21 to the eye-gaze detecting device 25.

The eye-gaze detecting device 25 searches the input wide-view-angle frame images to detect face regions (i.e., front faces and side faces), and if face regions have been detected, the eye-gaze detecting device 25 calculates feature quantities of each face to detect a direction of face and a direction of eyes, and based on them, detects the eye-gaze direction of the face (step S13).

The eye-gaze detecting device 25 sequentially inputs information, such as the eye-gaze directions, to the CPU 21. In addition, the CPU 21 detects the position of each detected face relative to the user based on the position in the combined image where the face region has been detected. Then, the CPU 21, based on the input eye-gaze direction and the position of the detected face relative to the user, determines whether or not the person with the detected human face region is looking at the protection target (cameras) (step S14).

The CPU 21 stores, e.g., the information input from the eye-gaze detecting device 25 and the determination result regarding whether or not the face is looking at the cameras, in the ROM area as log information on the face. The CPU 21, upon new information (information detected from the current frame) being input from the eye-gaze detecting device 25, determines whether or not an identical face is included in the frame one frame before, with reference to log information currently stored in the ROM region (step S15).

If it is determined at step S15 that an identical face is included in the current log information, the CPU 21 adds information detected from the current frame image and the determination result at step S14 to the log information on the identical face. If it has been determined at step S15 that no identical face is included in the current log information, the CPU 21 adds information detected from the current frame and the determination result at step S14 to the log information as information on a new face (step S16). Consequently, the log information is updated to the latest information.

The CPU 21 determines whether or not there are any faces looking at the cameras (that is, the user) for a given period of time or more, with reference to the log information (step S17).

If it has been determined that there are no faces looking at the cameras for a given period of time or more (No at step S17), the process returns to step S11 again, and the CPU 21 issues an instruction to the camera-#1 12 to camera-#5 16 to take images for the next frame. In this manner, whether or not there are any faces looking at the cameras for the given period of time or more is determined for the wide-view-angle moving image.

If it is determined that there is a face looking at the cameras for the given period of time or more (YES at step S17), the CPU 21 determines that the face looking at the cameras for the given period of time or more is a suspicious individual, and an audio warning message indicating the detection of the suspicious individual is output via the small speaker 18 (step S18). Consequently, the portable suspicious individual detection apparatus 1 can notify the user, which is the protection target, of danger to warn the user.

The CPU 21 stores the frame images from which the suspicious individual has been detected at step S17, in the ROM area (step S19). In addition, the CPU 21 issues an instruction to the GPS device 23 to acquire the positional information of the portable suspicious individual detection apparatus 1 and the current time information, and stores them in the ROM (step S20). Further, the CPU 21 performs processing for encoding input sounds collected by the small microphone 17, and stores the sound data in the ROM region.

The CPU 21 outputs the images stored in the ROM area, the positional information, the time information, the sound data, and the information indicating the detection of the suspicious individual to the mobile phone unit 24, and the mobile phone unit 24 sends theses pieces of information to an e-mail address registered in advance (step S21). Consequently, the information indicating that the suspicious individual has been detected can be sent to a remote location. In addition, as a result of sending the positional information and the time information, information on the position of the suspicious individual and the time at which the suspicious individual was found out in addition to the existence of the suspicious individual can be sent. Furthermore, by sending the sound information collected by the microphone, information on the circumstances when the suspicious individual was found out can be sent. After the e-mail transmission, the CPU 21 stops the processing, and performs the processing at step S11 again.

According to the present embodiment, when it has been determined that there is suspicious behavior, the user, which is the protection target, is notified of danger. Consequently, merely by making the protection target wear the glasses, the protection target can be protected from danger, enabling the protection target to avoid danger.

In addition, the present embodiment enables notifying the protection target of danger, and sending suspicious individual detection information and an image in which the suspicious individual is taken to a remote location, for example, a device such as a guardian's mobile phone or a computer (PC) provided to the school. Further, information useful for protection activities for a user and criminal searching, such as images of the suspicious individuals and positional information can be provided.

Also, while in the present embodiment, whether or not there are any faces looking at the cameras for a given period of time or more is determined at step S17, and if it is determined that there is a face looking at the cameras for the given period of time or more, the person with that face is determined to be a suspicious individual, the determination method for suspicious individuals is not limited to this. For example, the CPU 21 can calculate the distance to the face region detected from an image is calculated and, when the distance is not greater than a predetermined distance, determine that the person is a suspicious individual. The distance to the face region detected from the image can be calculated based on, e.g., a distance to the subject and/or the size of the face region detected.

While in the present embodiment, a face region of subject is detected from an image to detect a person from the subject image, the method for detecting a person is not limited to this, a person may be detected by detecting a human head (for example, the back of the head).

While in the present embodiment, the position in a combined image where the face region has been detected is obtained, and whether or not the person whose face region has been detected is looking at the protection target (cameras) is determined based on the position, in addition to this, the position of the detected face relative to the user may be detected based on the position in the image where the face region has been detected. Then, if the person with that face is determined to be a suspicious individual, the user is notified of the position of the person relative to the user, enabling the user to properly know the position of the suspicious individual, and more reliably avoid danger.

While in the present embodiment, if a face region is detected at step S13, feature quantities of the face are calculated to detect the direction of the face and the direction of the eyes, the age and/or the gender may be detected based on the feature quantities of the face in addition to the direction of the face and the direction of the eyes. Then, if the person with that face is determined to be a suspicious individual, the user is notified of detailed information such as the gender and/or age of the suspicious individual in addition to the existence of the suspicious individual, enabling the user to properly know who is the suspicious individual, and more reliably avoid danger.

While in the present embodiment, the current time information is acquired by the GPS device 23, the acquisition of the time information is not limited to the case using a GPS device, and the time information may be acquired using, e.g., standard time radio wave or radio wave. Also, the time information can be retained by the portable suspicious individual detection apparatus 1 using, i.e., an internal clock.

While in the present embodiment, whether or not there are any faces looking at the cameras for a given period of time or more is determined at step S17, and if there is a face looking at the cameras for a given period of time or more, the face is determined to be a suspicious individual, a face continuously looking at the cameras for a given period of time or more may be determined to be a suspicious individual since in many cases a suspicious individual continuously gazes at the target.

While in the present embodiment, if a person in an image is determined at step S18 to be a suspicious individual, an audio warning message indicating the detection of the suspicious individual is output via the small speaker 18, the method for outputting an audio message to indicate that a suspicious individual has been detected is not limited to the method in which an audio message is output. For example, a motor or the like may be provided to the glasses body 11 to issue a warning by making the motor vibrate, or a crystal-liquid panel, which is transparent under normal conditions, may be provided to the lens parts of the glasses to display a warning message or a frame image in which a suspicious individual has been detected on the liquid-crystal panel.

While in the present embodiment, five images taken by the camera-#1 12 to camera-#5 16 at step S12 are combined, and a face region is detected from the combined image at step S13, it is possible that five images are not combined but a face region may be detected from the respective subject images.

While in the present embodiment, five cameras, i.e., the camera-#1 12 to camera-#5 16, are provided, the number and positions of cameras are not limited to those in this embodiment.

While the present embodiment has been described in terms of the case where a plurality of cameras are provided to glasses, the present invention is not limited to glasses, and can be applied to any wearable items. For example, a configuration in which a plurality of cameras are provided to, e.g., a hat or a helmet may be employed. In the case of the configuration in which a plurality of cameras are provided to, e.g., a hat or a helmet, images of subjects behind the wearer can be taken. Accordingly, the wearer can be protected for an angle of 360°.

The present invention is not limited to devices such as glasses, and can be provided as a program to be installed in a device. Further, the present invention also includes a computer-readable medium encoded with the computer program, the program including computer-executable instructions for controlling a computer to execute the functions of the suspicious individual detection apparatus.

What is claimed is:

1. A portable suspicious individual detection apparatus comprising:
a wearable image pick-up device to be put on a body of a user;
a face detecting device which detects a human face region from subject images successively taken by the image pick-up device detects;
an eye-gaze direction detecting device which detects an eye-gaze direction of a person with the detected human face region;
a sight determining device which determines whether or not the person with the detected human face region is looking at the user, based on the eye-gaze direction detected by the eye-gaze direction detecting device;
a time period detecting device which detects an amount of time during which the person with the detected human face region is looking at the user when the sight determining device determines that the person with the detected human face region is looking at the user;
a suspicious individual determining device which determines that the person with the detected human face region is a suspicious individual when the amount of time detected by the time period detecting device is a predetermined amount of time or more; and
a notification device which provides the user with information indicating the detection of the suspicious individual when the suspicious individual determining device determines that the person with the detected human face region is the suspicious individual.

2. The portable suspicious individual detection apparatus according to claim 1,
wherein the face region detecting device detects, based on the detected human face region, and a face direction and a pupil position of the person with the detected human face region, and
wherein the eye-gaze direction detecting device detects the eye-gaze direction of the person with the detected human face region, based on the face direction and the pupil position of the person detected by the face region detecting device.

3. The portable suspicious individual detection apparatus according to claim 1, further comprising
a person position detecting device which detects a position of the person with the detected human face region relative to the user,
wherein the notification device notifies the user of the position of the person with the detected human face region relative to the user, the position being detected by the person position detecting device when the suspicious individual determining device determines that the person with the detected human face region is a suspicious individual.

4. The portable suspicious individual detection apparatus according to claim 1, further comprising
an age/gender determining device which detects at least one of a gender and an age of the person with the detected human face region, based on the detection result of the human face region,
wherein the notification device notifies the user of at least one of the gender and the age detected by the age/gender determining device when the suspicious individual determining device determines that the person with the detected human face region is a suspicious individual.

5. The portable suspicious individual detection apparatus according to claim 1, further comprising
a distance estimating device which estimates a distance to the person with the detected human face region,
wherein the notification device provides the user with a warning when the suspicious individual determining device determines that the person with the detected human face region is a suspicious individual and when the distance to the person with the detected human face region estimated by the distance estimating device become a predetermined distance or less.

6. The portable suspicious individual detection apparatus according to claim 1, further comprising
a transmission device which transmits information indicating that the suspicious individual is detected, and an image of the suspicious individual taken by the image pick-up device to an external device when the suspicious individual determining device determines that the person with the detected human face region is the suspicious individual.

7. The portable suspicious individual detection apparatus according to claim 6, further comprising
an apparatus position acquiring device that acquires positional information for the portable suspicious individual detection apparatus,
wherein the transmission device transmits the positional information acquired by the device position acquiring device when the suspicious individual determining device determines that the person with the detected human face region is a suspicious individual.

8. The portable suspicious individual detection apparatus according to claim 6, further comprising
a time information acquiring device which acquires information on a time when the suspicious individual determining device determines that the person with the detected human face region is a suspicious individual,
wherein the transmission device transmits the time information acquired by the time information acquiring device when the suspicious individual determining device determines that the person with the detected human face region is a suspicious individual.

9. The portable suspicious individual detection apparatus according to claim 6, further comprising
a microphone which collects sound information around the user,
wherein the transmission device transmits the sound information collected by the microphone when the suspicious individual determining device determines that the person with the detected human face region is a suspicious individual.

10. The portable suspicious individual detection apparatus according to claim 1, wherein the image pick-up device includes:
a plurality of image sensors; and
a plurality of taking lenses which form subject images in different directions from the user on the plurality of image sensors.

11. The portable suspicious individual detection apparatus according to claim 10,
wherein the plurality of taking lenses are provided to the image pick-up device in a manner that the plurality of subject images formed on the plurality of image sensors partially overlap,
the portable suspicious individual detection apparatus further comprises a combination device which combines overlapping parts of the plurality of subject images formed on the plurality of image sensors in a manner that the plurality of subject images partially overlap, to create a composite image, and
the face detecting device detects the human face region from the composite image created by the combination device.

12. The portable suspicious individual detection apparatus according to claim 10, wherein the image pick-up device is provided on a pair of glasses, and takes at least subject images in front of, and to the left and right of the user.

13. The portable suspicious individual detection apparatus according to claim 10, wherein the image pick-up device is provided on a hat or a helmet, and takes at least an subject image behind the user.

14. A suspicious individual detection method comprising:
an image taking step for successively taking subject images using a wearable image pick-up device;
a face detecting step for detecting a human face region from the successively-taken subject images;
an eye-gaze direction detecting step for detecting an eye-gaze direction of a person with the detected human face region;
a sight determining step for determining whether or not the person with the detected human face region is looking at a user of the wearable image pick-up device, based on the detected eye-gaze direction;
a time period detecting step for detecting an amount of time during which the person with the detected human face region is looking at the user when it is determined that the person with the detected human face region is looking at the user at the sight determining step;
a suspicious individual determining step for determining whether or not the person with the detected human face region is a suspicious individual based on the detected amount of time; and
a notification step for providing the user with information indicating the detection of the suspicious individual when it is determined that the person with the detected human face region is a suspicious individual at the suspicious individual determining step.

15. A computer-readable medium encoded with a computer program, the program comprising computer-executable instructions to make a computer execute the portable suspicious individual detection method according to claim 14.
